(19) United States
(12) Patent Application Publication
(10) Pub. No.: US 2018/0184385 A1
(43) Pub. Date: Jun. 28, 2018

(54) IEEE 802.11ax POWER LIMIT NEGOTIATION

(71) Applicant: INTEL IP CORPORATION, SANTA CLARA, CA (US)

(72) Inventors: Sefi KRAEMER, Ein Carmel (IL); Ofer GUETA, Ganei-Tikva (IL); Ilan SUTSKOVER, Hadera (IL); Eran SEGEV, Tel Aviv (IL)

(21) Appl. No.: 15/388,345

(22) Filed: Dec. 22, 2016

(51) Int. Cl. H04W 52/36

(52) U.S. Cl. CPC H04W 52/365; H04W 84/12

(57) ABSTRACT

Currently, transmission power of a STA in multi-user uplink environment is determined by the AP without addressing STA considerations that relate to voltage, power use, power saving, overhead, etc., and in general relate to the STA's power consumption (All of which can have secondary effects such as interference, etc.). By adopting the protocol and/or the restriction on assigned transmission power per STA, better power consumption can be achieved for the STA. In accordance with an exemplary embodiment, techniques are disclosed that employ the concept of such a restriction and a protocol, as well as a technique and device to implement the concept.

### TECHNICAL FIELD

An exemplary aspect is directed toward communications systems. More specifically an exemplary aspect is directed toward wireless communications systems and even more specifically to interference management in wireless networks. Even more particularly, an exemplary aspect is directed toward power limits and power savings.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary device, such as a wireless device for use with the techniques disclosed herein;

FIG. 2 illustrates a flow or fencepost diagram of the operation of an exemplary station and access point;

FIG. 3 illustrates another exemplary flow or fencepost diagram of the operation of an exemplary station and access point; and

FIG. 4 illustrates yet another flow or fencepost diagram of the operation of an exemplary station and access point.

### DESCRIPTION OF EMBODIMENTS

The IEEE 802.11ax specification defines a new technique to control station (STA) output power. The Access Point (AP) assigns output power for each STA via a trigger packet. The STA is assumed to transmit data within +/−3 dB of the assigned power from AP. However, this technique is limited to multi-user uplink methods, and has no option for the STA to make a request to optimize its work flow or operation.

In the technique, the AP may update the target transmit power per packet, which requires the STA to be prepared to adapt the STAs internal settings on a short notice (e.g., RF (Radio Frequency) & PA (Power Amplifier) supply voltage, PA pre-distortion tables, bias configurations, etc.). Changing these settings often takes time for the STA—the transition must be slow to avoid spurs on transmissions and to avoid gain changes in reception. The trigger packet from the AP to change the output power in the following frame does not leave enough time for a smooth transition, thus, the STA may be forced to be always set to a worst case power output.

One impact of fixing the setting to a worst-case means that the receiver is required to run at a high supply voltage (e.g., in 28 nm at 1.8V or 2.0V, instead of 1.2V or 1.4V with the same current, which is a 30% power impact on the RF components; transmitter in low output power can be at 1.4V instead of 1.8V or 2.0V with the same current, a 25-30% power impact).

In accordance with an exemplary embodiment, a STA negotiates a maximum transmitter power delta the AP will apply towards the STA. The AP then assigns a transmission power that has limited packet-to-packet transmission power differences, based, for example, on a negotiated delta. The protocol for this negotiation could be defined in, for example, a specification, such as the IEEE 802.11ax standard and/or could be a proprietary value-add end-to-end feature.

The implications of this approach are as follows: the STA knows that transmission power of a next packet cannot exceed a certain value and therefore the STA can pick an optimal or improved configuration. Additionally, and upon receiving a new trigger packet from the AP, the STA can update its configuration, but due to the limited delta in packet-to-packet transmission power differences, the STA can still improve performance.

Currently transmission power of a STA in multi-user uplink environment is determined by the AP without addressing STA considerations that relate to voltage, power use, etc., that relate to the STA's power consumption. By adopting the protocol and/or the restriction on assigned transmission power per STA, better power consumption can be achieved for the STA. In accordance with an exemplary embodiment, techniques are disclosed that employ the concept of such a restriction and a protocol, technique and device to implement it.

The following flow is currently proposed for IEEE 802.11ax, whereby an AP tells a STA the required signal power as would be observed by the AP receiver, via a trigger packet. This current scheme, based on the motion passed in IEEE and DensiFi is as follows:

AP signals the following in the Trigger frame that schedules the UL MU transmission
In the common info field: AP Tx Power: Tx_{pwr}^{AP}(dBm)
In the per user info field: Target_{RSSI}(dBm) for each STA that is scheduled in the Trigger frame
   The number of bits in the Target RSSI (Received Signal Strength Indicator) is TBD
STA sets its Tx power per the following equation

Tx_{pwr}^{STA}(dBm)=PL_{DL}(dB)+Target_{RSSI}(dBm)
where PL_{DL}(dB) is the DL (downlink) path loss computed by the STA based on the AP transmit power signalled in the Trigger message and the measured RSSI of the Trigger message
Target_{RSSI}(dBm) is signalled by the AP in the trigger message

An exemplary embodiment adds a negotiation flow between the STA and AP that allows the STA to request from the AP, either:
An explicit limit on the increase of signal power between any 2 trigger packets,
An explicit limit on the increase of signal power in the next trigger packet,
An implicit limit by indicating how much power present clearance the STA currently has, or
A similar way to negotiate a limit to the change step of signal power.

Details of these options will be discussed herein in relation to the figures.

It should be appreciated that for any of these techniques that the AP may reject a request of client (STA), which forces the client (STA) to abide by a AP's requirement even if it means running at higher output power than is optimal for power consumption.

Some exemplary advantages associated with the short term certainty of output power at least include: (1) By knowing the transmit power limit in the next packet, the STA can adjust its voltage supply to the minimum possible thus achieving optimal or improved power usage. Otherwise, a fast voltage transition to adapt to a leap in output power may not be feasible (see time analysis below). (2) A fast transition in settings in a given moment limits the degree of freedom to mitigate co-existence problems and other transient related effects. For example, a sharp dV/dt aggression (instantaneous rate of voltage change over time) on the supply voltage is likely to interfere with another wireless active core running at the same time (e.g., Bluetooth). Having the freedom to plan the timing of such a transition and having the time budget to smooth the transition can eliminate or reduce such co-existence interference.

Time is of the essence for updating configurations because the budget on air between reception of a trigger packet and the following transmission is very limited (e.g., SIFS). Yet, the latency for receiving the last symbol of the trigger packet, processing it and preparing the following packet for transmission leaves typically 2-5 us for the whole transmission lineup turn on and setup.

Updating the output power may also require changes in supply voltage. These changes must be met within the leftover budget and may constrain the changes even further.

Additionally, the battery and power are shared resources, thus changing voltage supply (e.g., raising it by 400-600 mV) with high current (>1A) can impact the performance of other components in the platform directly supplied by battery. Examples of impacts on such components are high battery in-rush current and supply voltage droops. On the other hand, from the point of view of the RF system itself, common RF implementations use a regulated supply (e.g., DCDC); with typical capacitor and inductor setups, the time to raise voltage while maintaining current supply stable takes more than 5 us. (Note: inductor current limiters and external component selection can directly impact the DCDC output voltage slew rate).

It's clear, therefore, that a knowledge of the upcoming range of change allows the STA to pre-empt the supply change and apply the change during, for example, idle, reception time or some other “down” time, otherwise there may not be enough time to do the supply change and the client is forced to always be at the highest voltage. The techniques discussed herein have the further advantage that the settings can be updated without impacting user experience. Thus, overcomes one problem of prior solutions where if a client (STA) negotiates with an AP on a limit, but the AP, for some reason, triggers a request much beyond what it agreed upon during negotiation, the client is likely to transmit at lower power than AP requested as the client depends on the limitation agreed upon.

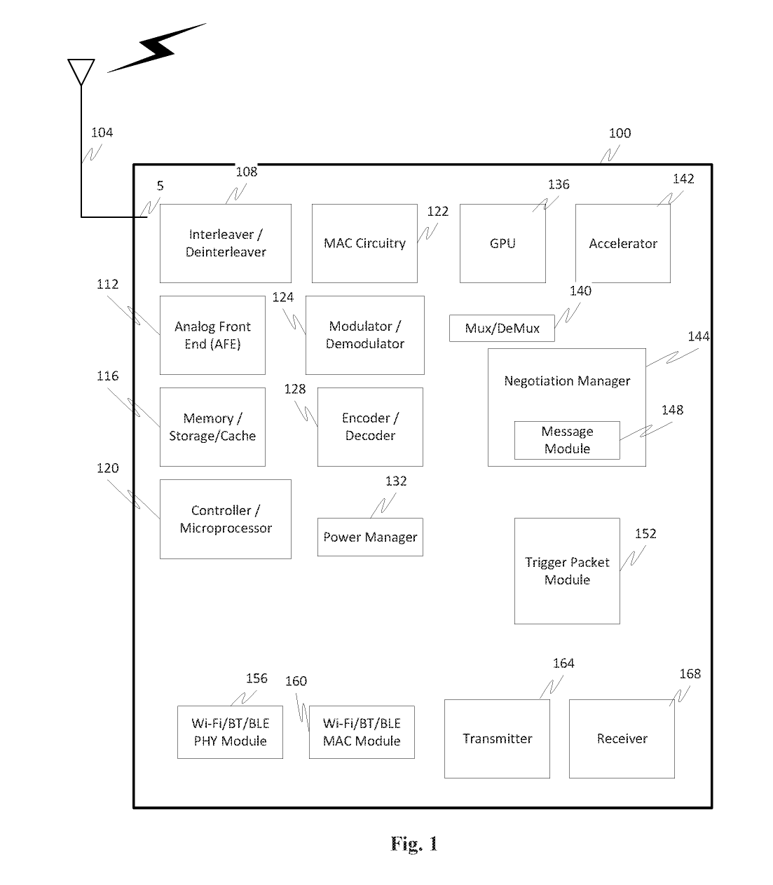

FIG. 1 illustrates an exemplary hardware diagram of a device 100, such as a wireless device, mobile device, access point, station, and/or the like, that is adapted to implement the technique(s) discussed herein. Operation will be discussed in relation to the components in FIG. 1 appreciating that each separate device in a system, e.g., station, AP, proxy server, etc., can include one or more of the components shown in the figure, with the components each being optional.

In addition to well-known componentry (which has been omitted for clarity), the device 100 includes interconnected elements (with links 5 omitted for clarity) including one or more of: one or more antennas 104, an interleaver/deinterleaver 108, an analog front end (AFE) 112, memory/storage/cache 116, controller/microprocessor 120, MAC circuitry 122, modulator/demodulator 124, encoder/decoder 128, power manager 132, GPU 136, accelerator 142, a multiplexer/demultiplexer 140, a negotiation manager 144, message module 148, trigger packet module 152, and wireless radio components such as a Wi-Fi/BT/BLE PHY module 156, a Wi-Fi/BT/BLE MAC module 160, transmitter 164 and receiver 168. The various elements in the device 100 are connected by one or more links (not shown, again for sake of clarity). As one example, the negotiation manager 144 and message module 148 can be embodied as a process executing on a processor or controller, such as processor 120 with the cooperation of the memory 116. The negotiation manager 144 and message module 148 could also be embodied as an ASIC and/or as part of a system on a chip.

The device 100 can have one more antennas 104, for use in wireless communications such as multi-input multi-output (MIMO) communications, multi-user multi-input multi-output (MU-MIMO) communications Bluetooth®, LTE, RFID, 4G, LTE, etc. The antenna(s) 104 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 104 generally interact with the Analog Front End (AFE) 112, which is needed to enable the correct processing of the received modulated signal and signal conditioning for a transmitted signal. The AFE 112 can be functionally located between the antenna and a digital baseband system in order to convert the analog signal into a digital signal for processing and vice-versa.

The device 100 can also include a controller/microprocessor 120 and a memory/storage/cache 116. The device 100 can interact with the memory/storage/cache 116 which may store information and operations necessary for configuring and transmitting or receiving the information described herein. The memory/storage/cache 116 may also be used in connection with the execution of application programming or instructions by the controller/microprocessor 120, and for temporary or long term storage of program instructions and/or data. As examples, the memory/storage/cache 120 may comprise a computer-readable device, RAM, ROM, DRAM, SDRAM, and/or other storage device(s) and media.

The controller/microprocessor 120 may comprise a general purpose programmable processor or controller for executing application programming or instructions related to the device 100. Furthermore, the controller/microprocessor 120 can perform operations for configuring and transmitting information as described herein. The controller/microprocessor 120 may include multiple processor cores, and/or implement multiple virtual processors. Optionally, the controller/microprocessor 120 may include multiple physical processors. By way of example, the controller/microprocessor 120 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 100 can further include a transmitter 164 and receiver 168 which can transmit and receive signals, respectively, to and from other wireless devices and/or access points using the one or more antennas 104. Included in the device 100 circuitry is the medium access control or MAC Circuitry 122. MAC circuitry 122 provides for controlling access to the wireless medium. In an exemplary embodiment, the MAC circuitry 122 may be arranged to contend for the wireless medium and configure frames or packets for communicating over the wireless medium.

The PHY Module/Circuitry 156 controls the electrical and physical specifications for device 100. In particular, PHY Module/Circuitry 156 manages the relationship between the device 100 and a transmission medium. Primary functions and services performed by the physical layer, and in particular the PHY Module/Circuitry 156, include the establishment and termination of a connection to a communications medium, and participation in the various process and technologies where communication resources shared between, for example, among multiple STAs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 156 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 122 handle co-ordination of interactions between the MAC and PHY layers.

The interleaver/deinterleaver 108 cooperates with the various PHY components to provide Forward Error correction capabilities. The modulator/demodulator 124 similarly cooperates with the various PHY components to perform modulation which in general is a process of varying one or more properties of a periodic waveform, referred to and known as a carrier signal, with a modulating signal that typically contains information for transmission. The encoder/decoder 128 manages the encoding/decoding used with the various transmission and reception elements in device 100.

The MAC layer and components, and in particular the MAC module 160 and MAC circuitry 122 provide functional and procedural means to transfer data between network entities and to detect and possibly correct errors that may occur in the physical layer. The MAC module 160 and MAC circuitry 122 also provide access to contention-based and contention-free traffic on different types of physical layers, such as when multiple communications technologies are incorporated into the device 100. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 100 can also optionally contain a security module (not shown). This security module can contain information regarding but not limited to, security parameters required to connect the device to an access point or other device or other available network(s), and can include WEP or WPA/WPA-2 (optionally +AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 142 can cooperate with MAC circuitry 122 to, for example, perform real-time MAC functions. The GPU 136 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

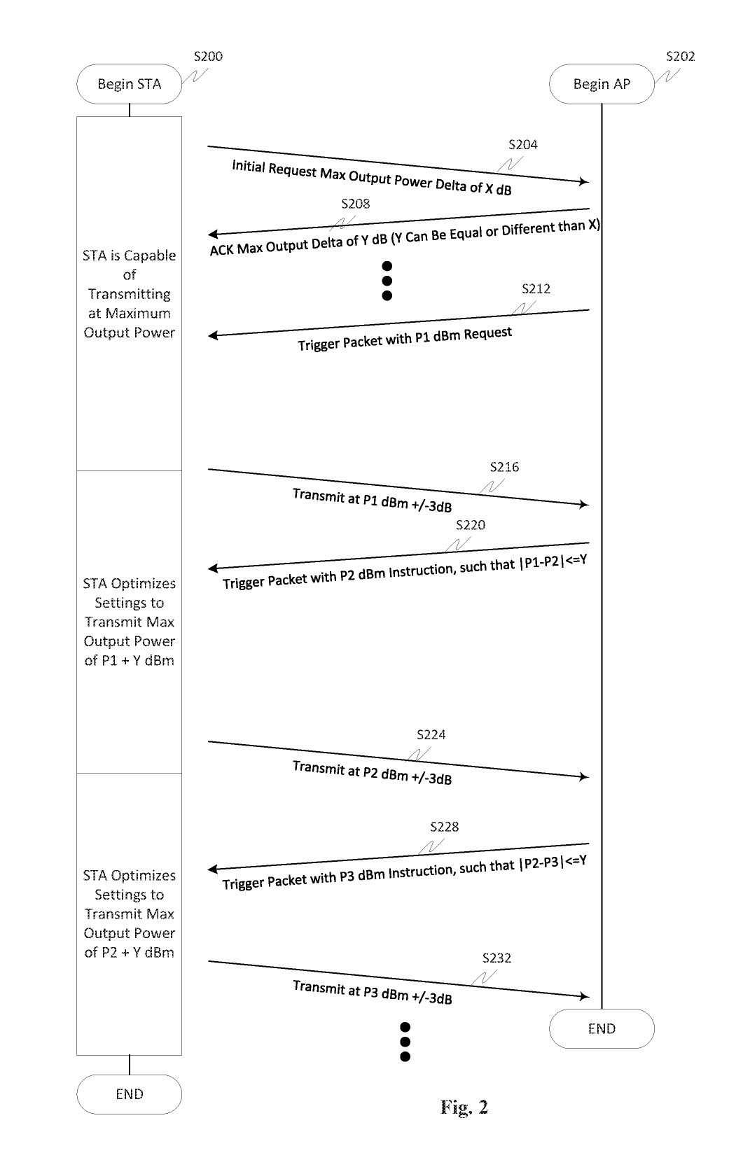

Operation of the device 100 will be described further in relation to the optional illustrative operations outlined in FIGS. 2-4. The first operational use case is for an explicit limit on the increase of signal power between any two trigger packets. The second operational use case is for an explicit limit on the increase of signal power in the next trigger packet. The third operational use case is for an implicit limit on signal power by indicating how much power present clearance the STA currently has. Of course the embodiments are not limited to the above, and in general any methodology or technique to limit the amount the signal power change is encompassed by the present disclosure.

The first operational use case can be considered a packet-to-packet maximum output power delta policy. The STA, and in particular the negotiation manager 144, together with the message module 148, processor 120 and transmitter 164, send an initial request to the AP. This initial request indicates a maximum output power delta of X dB. The AP, with its processor 120, negotiation manager 144, message module 148, and transmitter 164, acknowledge a maximum output power delta of Y dB, where Y can be equal to or different than X and transmit this information to the STA. The AP then transmits, with the cooperation of the trigger packet module 152 and transmitter 164, a trigger packet with a P1 dBm request (Power1). During this time, the STA is capable of transmitting at a maximum output power.

Next, the STA transitions to an improved setting of transmitting with a maximum output power of P1+Y dBm and transmits at P1 dBm+/−3 dB to the AP. In response, the AP transmits a trigger packet with a P2 dBm instruction, such that |P1−P2|<=Y. The STA then steps to transmit at P2 dBm+/−3 dB. At this point, the STA also transitions to improving its settings to transmit at a maximum output power of P2+Y dBm.

In response to the STA transmitting at P2 dBm+/−3 dB, the AP transmits to the STA a trigger packet with a P3 dBm instruction such that |P2−P3|<=Y. The STA then begins transmitting at P3 dBm+/−3 dB.

The second operational use case can be considered an adjustable maximum power output delta policy where there is an explicit limit on the increase of signal power in the next trigger packet. This technique will also be described in relation to STA components, and in particular the negotiation manager 144, the message module 148, processor 120 and transmitter 164, and AP components including processor 120, negotiation manager 144, message module 148, and transmitter 164.

During a period when the STA is capable of transmitting at a maximum output power, the STA transmits an initial request identifying a maximum output power delta of X dB. The AP returns an acknowledgement (ACK) specifying a maximum output power delta of Y dB, where Y can be equal to or different than X. The AP then transmits a trigger packet with a P1 dBm instruction.

Transitioning to improving its settings to transmit a maximum output power of P1+Y dBm, the STA transmits to the AP at P1 dBm+/−3 dB. The STA can then optionally send an update request to the AP requesting an updated maximum output power delta. The AP then responds with an ACK and a new maximum output power delta.

The STA then transitions to improving its settings to transmit at a maximum output power of P2+new delta dBm and receives a trigger packet with a P2 dBm instruction such that |P1−P2|<=new delta. The STA then commences transmission at P2 dBm+/−3 dB.

The third operational use case can be considered a headroom field negotiation, where the STA introduces an implicit limit by indicating how much power present clearance the STA has currently. This technique will also be described in relation to STA components, and in particular the negotiation manager 144, the message module 148, processor 120 and transmitter 164, and AP components including processor 120, negotiation manager 144, message module 148, and transmitter 164.

While in a maximum output power transmission mode, the STA receives from the AP a trigger packet with a P1 dBm request. The STA responds to the AP by transmitting at a target of P1 dBm=N1 dBm and transitions to improving its settings to transmit at a maximum output power as reported in a headroom field or message. The AP gets this new headroom value and limits its requests to the STA. Next, the AP sends a trigger packet to the STA with a P2 dBm instruction such that P1<=N1. The STA responds by transmitting at a target of P2 dBm=N2 dBm and transitions to improving its settings to transmit at a maximum output power as reported in a headroom field or message. Again, the AP gets this new headroom value and limits its requests to the STA and responds with a trigger packet with a P2 dBm instruction such that P2<=N2. The STA then transmits at a target of P3 dBm=N3 dBm. The process can then continue in the same manner.

FIG. 2 outlines exemplary operation of a packet-to-packet maximum output power delta policy between a STA and AP. Control begins for the STA in step S200 and for the AP in step S202. The STA in step S204 send an initial request to the AP. This initial request indicates a maximum output power delta of X dB. The AP, in step S208, sends an acknowledgement to the STA specifying a maximum output power delta of Y dB, where Y can be equal to or different than X. The AP then transmits, in step S212, a trigger packet with a P1 dBm request (Power1).

Next, in step S216, the STA transmits at P1 dBm+/−3 dB to the AP. The STA also transitions to improving or optimizing the STA's settings to transmit at a maximum output power of P1+Y dBm. In step S220, the AP transmits a trigger packet with a P2 dBm instruction, such that |P1−P2|<=Y. The STA, in step S224, then transmits to the AP at P2 dBm+/−3 dB (Power2). At this point, the STA also transitions to improving or optimizing the STA's settings to transmit at a maximum output power of P2+Y dBm.

In response to the STA transmitting at P2 dBm+/−3 dB, the AP, in step S228, transmits to the STA a trigger packet with a P3 (Power3) dBm instruction such that |P2−P3|<=Y. The STA, in step S232, then begins transmitting at P3 dBm+/−3 dB with control capable of continuing in a similar manner until the operational sequence ends.

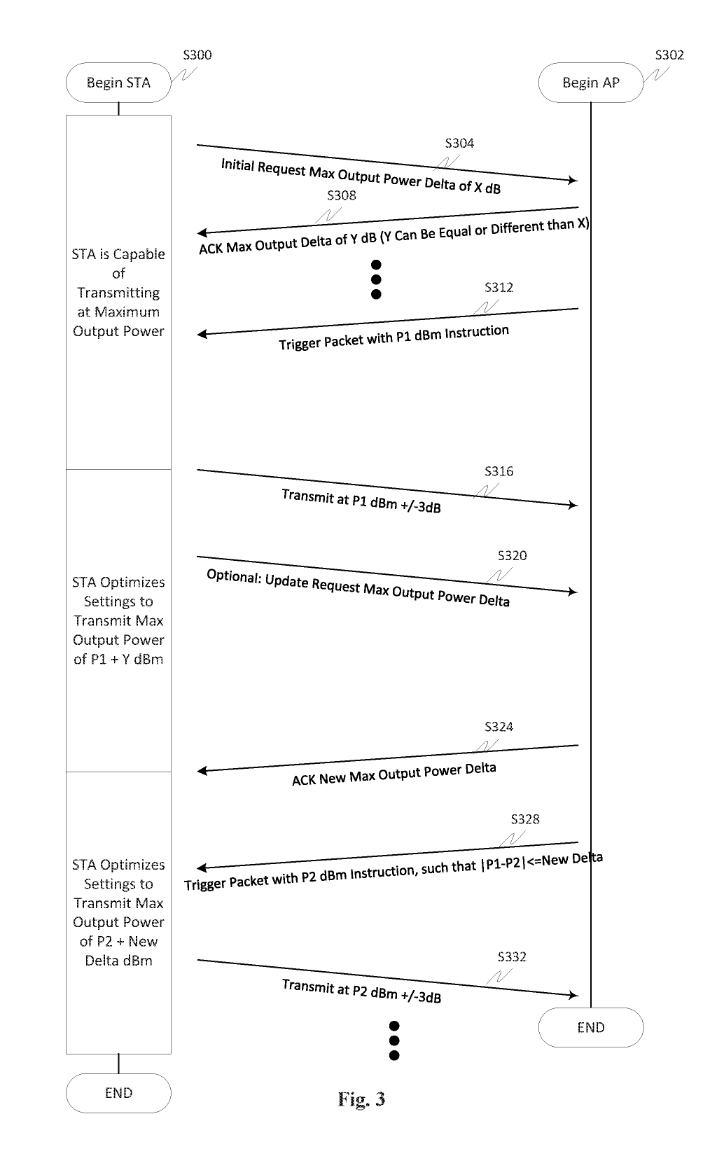

FIG. 3 outlines exemplary operation of an adjustable maximum power output delta policy where there is an explicit limit on the increase of signal power in the next trigger packet.

Control for the STA begins in step S300 and for the AP in step S302. During a period when the STA is capable of transmitting at a maximum output power, the STA in step S304 transmits an initial request identifying a maximum output power delta of X dB. The AP, in step S308, returns an acknowledgement (ACK) specifying a maximum output power delta of Y dB, where Y can be equal to or different than X. The AP, in step S312, then transmits a trigger packet with a P1 dBm instruction to the STA.

Transitioning to improving its settings to transmit a maximum output power of P1+Y dBm, the STA in step S316 transmits to the AP at P1 dBm+/−3 dB. The STA can then optionally, in step S320, send an update request to the AP requesting an updated maximum output power delta. The AP in step S324 then responds with an ACK and a new maximum output power delta.

With the STA transitioning to improving its settings to transmit at a maximum output power of P2+new delta dBm, in step S328 the STA receives a trigger packet with a P2 dBm instruction such that |P1−P2|<=new delta. The STA then commences, in step S332, transmission at P2 dBm+/−3 dB with control capable of continuing in a similar manner until the operational sequence ends.

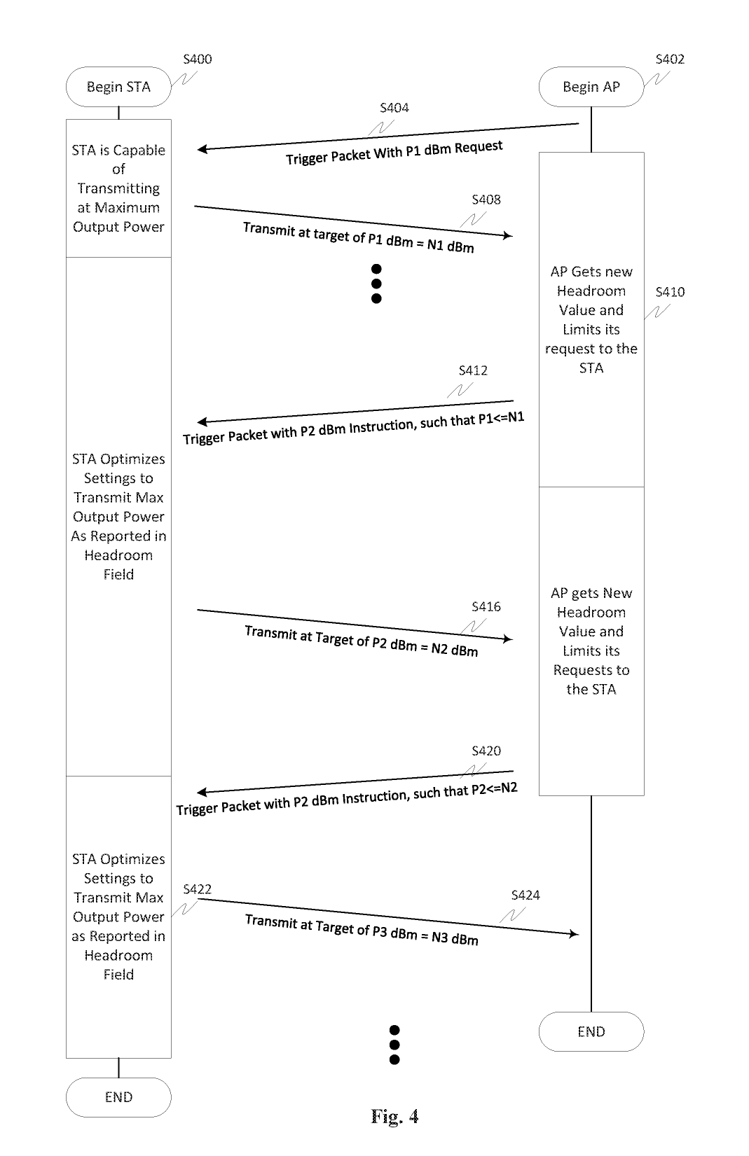

FIG. 4 outlines exemplary operation of a third use case that can be considered a headroom field negotiation, where the STA introduces an implicit limit by indicating how much power present clearance the STA has currently.

Control for the STA begins in step S400 and for the AP in step S402. While in a maximum output power transmission mode, the STA, in step S404, receives from the AP a trigger packet with a P1 dBm request. The STA in step S408 responds to the AP by transmitting at a target of P1 dBm=N1 dBm and transitions to improving or optimizing its settings to transmit at a maximum output power as reported in a headroom field or message.

The AP, in step S410, receives this new headroom value and limits its requests to the STA. Next, in step S412, the AP sends a trigger packet to the STA with a P2 dBm instruction such that P1<=N1. The STA, in step S416, responds by transmitting at a target of P2 dBm=N2 dBm and transitions, in step S422, to improving or optimizing its settings to transmit at a maximum output power as reported in a headroom field or message. Again, the AP gets this new headroom value and limits its requests to the STA and responds in step S420 with a trigger packet to the STA with a P2 dBm instruction such that P2<=N2. The STA, in step S424, then transmits at a target of P3 dBm=N3 dBm. The process can then continue in a similar manner until the operational sequence ends.

While the above description has been described in relation to trigger packets, it is to be appreciated that the various exchanges between the STA and AP can be any type of message that is capable of conveying the information associated with a particular step(s).

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:

a processor in communication with a negotiation manager, transmitter and receiver cooperating to exchange a plurality of messages with another wireless device, the messages specifying a limit of a packet-to-packet transmission power difference; and

a power manager that controls power for the device based on the limit.

Any of the above aspects, wherein the limit is explicit.
Any of the above aspects, wherein the limit is implicit.
Any of the above aspects, wherein the limit is based on headroom information.
Any of the above aspects, wherein the device receives a plurality of trigger packets, each trigger packet including an instruction for setting the limit.
Any of the above aspects, wherein the device with a messaging module forwards a message specifying a maximum output power delta.
Any of the above aspects, wherein a headroom value sets the limit, and the headroom value is updated after transmission at a prior limit.
Any of the above aspects, wherein the power manager controls power to at least an RF portion of the device.
Any of the above aspects, configured to one or more of save power and improve performance of the device.
Any of the above aspects, wherein the transmission power is managed for each device in a communications network.
A non-transitory information storage media having stored thereon one or more instructions, that when executed by one or more processors, cause a wireless device to perform a method comprising:
exchanging a plurality of messages with another wireless device, the messages specifying a limit of a packet-to-packet transmission power difference;
controlling a transmission power for the device based on the limit.
   Any of the above aspects, wherein the limit is explicit.
   Any of the above aspects, wherein the limit is implicit.
   Any of the above aspects, wherein the limit is based on headroom information.
   Any of the above aspects, wherein the device receives a plurality of trigger packets, each trigger packet including an instruction for setting the limit.
   Any of the above aspects, wherein the device with a messaging module forwards a message specifying a maximum output power delta.
   Any of the above aspects, wherein a headroom value sets the limit, and the headroom value is updated after transmission at a prior limit.
   Any of the above aspects, wherein the power manager controls power to at least an RF portion of the device.
   A wireless communications device comprising:
   means for exchanging a plurality of messages with another wireless device, the messages specifying a limit of a packet-to-packet transmission power difference; and
   means for controlling a transmission power for the device based on the limit.
   Any of the above aspects, further comprising means for controlling power to at least an RF portion of the device.
   A wireless communications device comprising:

a processor in communication with a negotiation manager, transmitter and receiver that exchange a plurality of messages with another wireless device, the messages specifying in a trigger packet a limit of a packet-to-packet transmission power difference.

Any of the above aspects, wherein the limit is explicit.
Any of the above aspects, wherein the limit is implicit.
Any of the above aspects, wherein the limit is based on headroom information.
Any of the above aspects, wherein the device transmits a plurality of trigger packets, each trigger packet including an instruction for setting the limit.
Any of the above aspects, wherein the device with a messaging module forwards a message specifying a maximum output power delta.
Any of the above aspects, wherein a headroom value sets the limit, and the headroom value is updated after transmission at a prior limit.
Any of the above aspects, wherein the limit is usable by a power manager that controls power to at least one portion or component of the another wireless device.
Any of the above aspects, configured to one or more of save power and improve performance of the device.
Any of the above aspects, wherein the transmission power is managed for each device in a communications network.
A non-transitory information storage media having stored thereon one or more instructions, that when executed by one or more processors, cause a wireless device to perform a method comprising:
exchanging a plurality of messages with another wireless device, the messages specifying in a trigger packet a limit of a packet-to-packet transmission power difference.
Any of the above aspects, wherein the limit is explicit.
Any of the above aspects, wherein the limit is implicit.
Any of the above aspects, wherein the limit is based on headroom information.
Any of the above aspects, wherein the device transmits a plurality of trigger packets, each trigger packet including an instruction for setting the limit.
Any of the above aspects, wherein the device with a messaging module forwards a message specifying a maximum output power delta.
Any of the above aspects, wherein a headroom value sets the limit, and the headroom value is updated after transmission at a prior limit.
Any of the above aspects, wherein the limit is usable by a power manager that controls power to at least one portion or component of the another wireless device.
A wireless communications device comprising:
means for assembling a plurality of messages for another wireless device, the messages specifying in a trigger packet a limit of a packet-to-packet transmission power difference; and means for transmitting the trigger packet.
Any of the above aspects, wherein the limit is usable by a power manager that controls power to at least one portion or component of the another wireless device.

A system on a chip (SoC) including any one or more of the above aspects and/or component(s).

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, circuitry or combination thereof, that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a processor in communication with a negotiation manager, transmitter and receiver cooperate to exchange a plurality of messages with another wireless device, the messages specifying a limit of a packet-to-packet transmission power difference; and
a power manager to control power for the device based on the limit.

2. The device of claim 1, wherein the limit is explicit.

3. The device of claim 1, wherein the limit is implicit.

4. The device of claim 1, wherein the limit is based on headroom information.

5. The device of claim 1, wherein the device receives a plurality of trigger packets, each trigger packet including an instruction for setting the limit.

6. The device of claim 1, wherein the device with a messaging module forwards a message specifying a maximum output power delta.

7. The device of claim 1, wherein a headroom value sets the limit, and the headroom value is updated after transmission at a prior limit.

8. The device of claim 1, wherein the power manager controls power to at least an RF portion of the device.

9. The device of claim 1, configured to one or more of save power and improve performance of the device.

10. The device of claim 1, wherein the transmission power is managed for each device in a communications network.

11. A non-transitory information storage media having stored thereon one or more instructions, that when executed by one or more processors, cause a wireless device to perform a method comprising:
exchanging a plurality of messages with another wireless device, the messages specifying a limit of a packet-to-packet transmission power difference;
controlling a transmission power for the device based on the limit.

12. The media of claim 11, wherein the limit is explicit.

13. The media of claim 11, wherein the limit is implicit.

14. The media of claim 11, wherein the limit is based on headroom information.

15. The media of claim 11, wherein the device receives a plurality of trigger packets, each trigger packet including an instruction for setting the limit.

16. The media of claim 11, wherein the device with a messaging module forwards a message specifying a maximum output power delta.

17. The media of claim 16, wherein a headroom value sets the limit, and the headroom value is updated after transmission at a prior limit.

18. The media of claim 11, wherein the power manager controls power to at least an RF portion of the device.

19. A wireless communications device comprising:
means for exchanging a plurality of messages with another wireless device, the messages specifying a limit of a packet-to-packet transmission power difference; and
means for controlling a transmission power for the device based on the limit.

20. The device of claim 19, further comprising means for controlling power to at least an RF portion of the device.
